(19) United States
(12) Patent Application Publication
(10) Pub. No.: US 2015/0186976 A1
(43) Pub. Date: Jul. 2, 2015

(54) SET SALES PROCESSING SYSTEM

(71) Applicant: DeNA Co., Ltd., Tokyo (JP)

(72) Inventors: Takashi OHKUBO, Tokyo (JP); Yusuke SUMAKI, Tokyo (JP)

(21) Appl. No.: 14/529,268

(22) Filed: Oct. 31, 2014

(30) Foreign Application Priority Data
Dec. 27, 2013 (JP) 2013-272752

(51) Int. Cl. G06Q 30/06; A63F 13/792

(52) U.S. Cl. CPC G06Q 30/0631; G06Q 30/0611; G06Q 30/0643; A63F 13/792

(57) ABSTRACT

A set sales processing system includes an accepting unit that receives input of set sales information including combinations of identification information respectively corresponding to types of items to be sold in a set, numbers of the respective items to be included in the set, and a price of the set; and a providing unit that acquires, from a storing unit, a plurality of item images respectively corresponding to the identification information of the types of items included in the set sales information, wherein the storing unit stores, for each of the types of items, identification information and one of the item images in association with each other, and generates a set sales screen including a set image in which the item images, the numbers, and the price are incorporated in a template screen including combinations of item image display areas and number display areas, and a price display area.

### CROSS-REFERENCE TO RELATED APPLICATION

The present application is based on and claims the benefit of priority of Japanese Priority Application No. 2013-272752 filed on Dec. 27, 2013, the entire contents of which are hereby incorporated by reference.

### BACKGROUND OF THE INVENTION

1. Field of the Invention

The present invention relates to a set sales processing system.

2. Description of the Related Art

In online shopping using the Internet, images of items (merchandise items) that are sold are displayed, so that the purchaser can easily understand what the items are. For example, Patent Document 1 describes a structure for displaying a result obtained by combining a merchandise item with another merchandise item so that a comparison can be made.

Patent Document 1: Japanese Laid-Open Patent Publication No. 2011-44053

However, conventionally, when the vendor combines a plurality of items and sells the combination as a set, a single image including the plurality of items has been displayed. In this case, it has been difficult for the purchaser to immediately confirm what kind of items are included in the displayed image. Furthermore, the vendor needs to create an image for each set including a plurality of items, which increases the number of processes.

### SUMMARY OF THE INVENTION

The present invention is made in light of the above problems, and provides a technique capable of simplifying the process when selling a plurality of items as a set, and enhancing flexibility.

According to an embodiment, there is provided a set sales processing system including a set sales information accepting unit that receives input of set sales information including combinations of identification information respectively corresponding to a plurality of types of items to be sold in a set, numbers of the respective items to be included in the set, and a price of the set; a set sales screen providing unit that acquires, from an item information storing unit, a plurality of item images respectively corresponding to the identification information of the plurality of types of items included in the set sales information, wherein the item information storing unit stores, for each of the plurality of types of items, identification information and one of the plurality of item images in association with each other, based on the set sales information, and generates a set sales screen including a set image in which the plurality of item images, the numbers, and the price are incorporated in a template screen, the template screen including a plurality of combinations of item image display areas and number display areas, and a price display area; and an item proposing unit that receives, from a purchaser, a process to exclude, from an actual one of the set, all of or some of a type of item among the plurality of types of items corresponding to the plurality of item images included in the set image, and proposes, to the purchaser based on history information relevant to usage of items by the purchaser, an item that is a same type as an item that is highly frequently used by the purchaser, as a candidate item to be included in the set instead of all of or some of the type of item that has been processed to be excluded from the set.

### BRIEF DESCRIPTION OF THE DRAWINGS

Other objects, features and advantages of the present invention will become more apparent from the following detailed description when read in conjunction with the accompanying drawings.

FIG. 1 is a block diagram illustrating an example of a network structure of an embodiment;

FIG. 2 is a block diagram illustrating an example of a hardware structure of a user terminal device of the embodiment;

FIG. 3 is a block diagram illustrating an example of a hardware structure of a set sales processing system of the embodiment;

FIG. 4 is a block diagram illustrating an example of a functional structure of the terminal devices and the set sales processing system of the embodiment;

FIG. 5 illustrates an example of the internal structure of an item information storing unit of the embodiment;

FIG. 6 illustrates an example of an input screen of set sales information of the embodiment;

FIG. 7 illustrates an example of the internal structure of a set sales information storing unit of the embodiment;

FIG. 8 illustrates an example of a template screen based on template information of the embodiment;

FIG. 9 illustrates an example of a set sales screen of the embodiment;

FIG. 10 illustrates an example of the internal structure of a user information storing unit of the embodiment;

FIG. 11 is a flowchart of an example of processing procedures of the set sales processing system of the embodiment;

FIG. 12 illustrates another example of the internal structure of a set sales information storing unit of the embodiment; and

FIG. 13 illustrates another example of the set sales screen of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

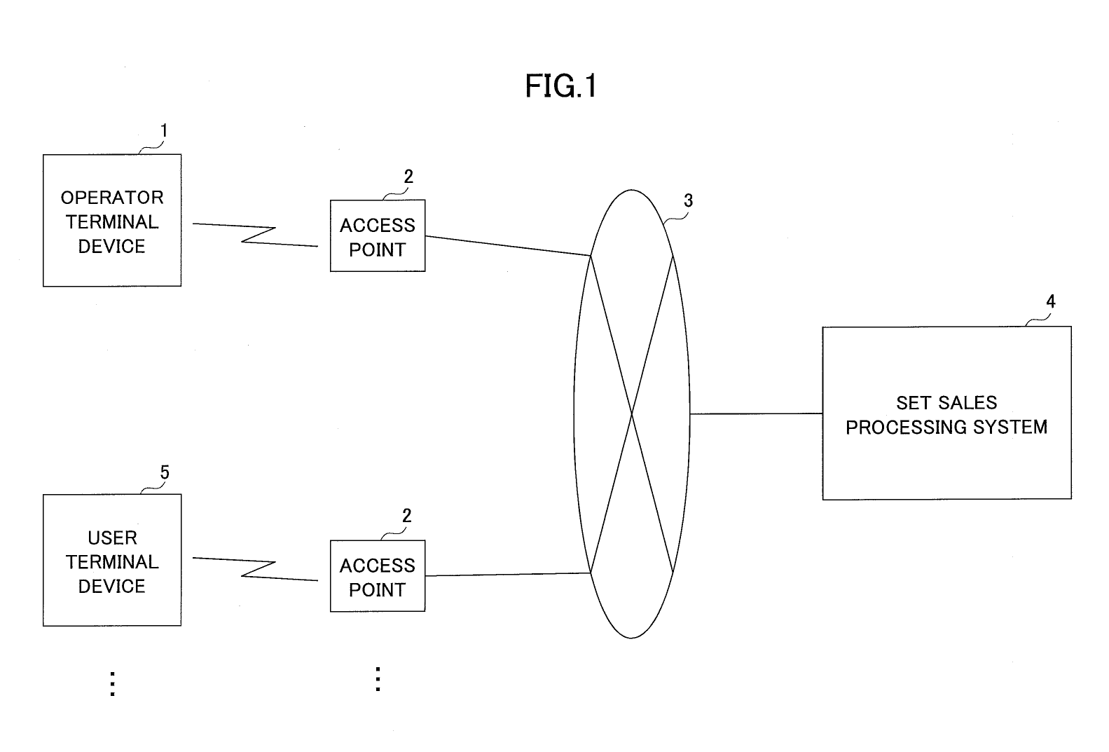

FIG. 1 is a block diagram illustrating an example of a network structure of the embodiment.

The network structure includes an operator terminal device 1 operated by an operator, a user terminal device 5 operated by a user, an access point 2 such as a mobile wireless base station and a Wi-Fi station, a network 3 such as the Internet, and a set sales processing system 4 for performing a process (control) of selling sets of a plurality of items. The set sales processing system 4 is connected to a plurality of operator terminal devices 1 and user terminal devices 5 via the network 3. The operator terminal device 1 and the user terminal device 5 are an information processing device such as a mobile phone, a smartphone, a game console, a personal computer, a touch pad, and an electronic book reader.

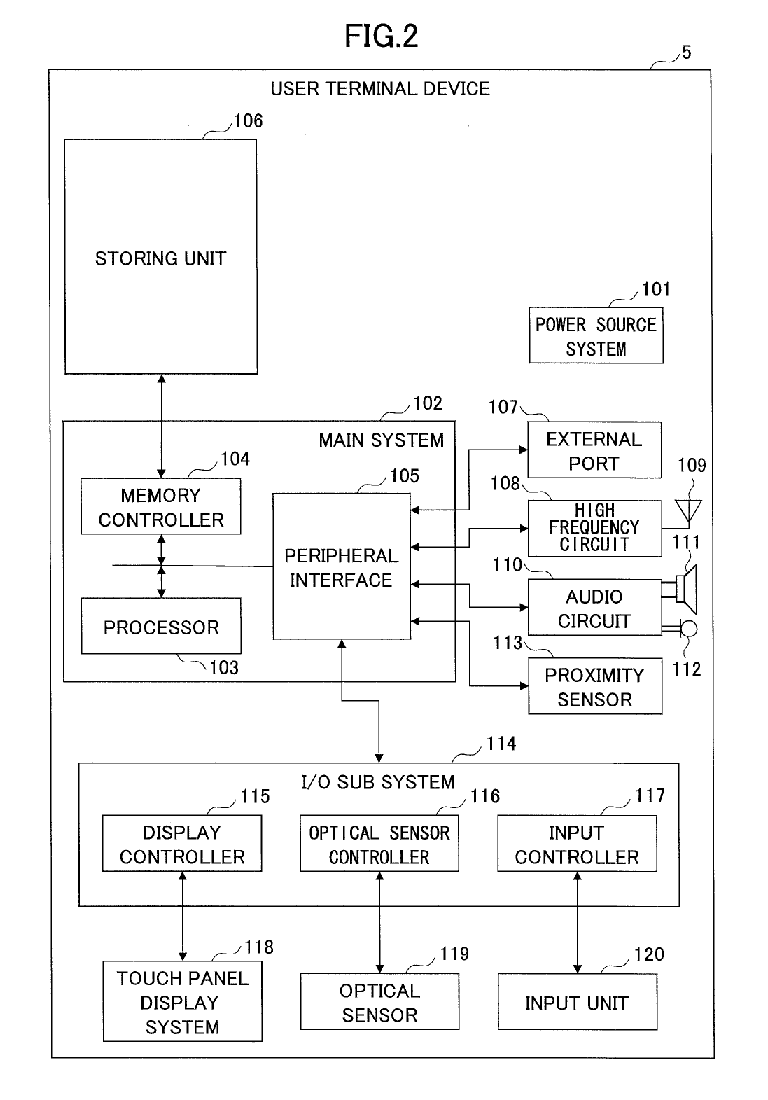

FIG. 2 is a block diagram illustrating an example of a hardware structure of the user terminal device 5 of the embodiment.

The user terminal device 5 includes a power source system 101, a main system 102, a storing unit 106, an external port 107, a high frequency circuit 108, an antenna 109, an audio circuit 110, a speaker 111, a microphone 112, a proximity sensor 113, an I/O (Input/Output) sub system 114, a touch panel display system 118, an optical sensor 119 and an input unit 120. The main system 102 includes a processor 103, a memory controller 104, and a peripheral interface 105. The I/O sub system 114 includes a display controller 115, an optical sensor controller 116, and an input controller 117.

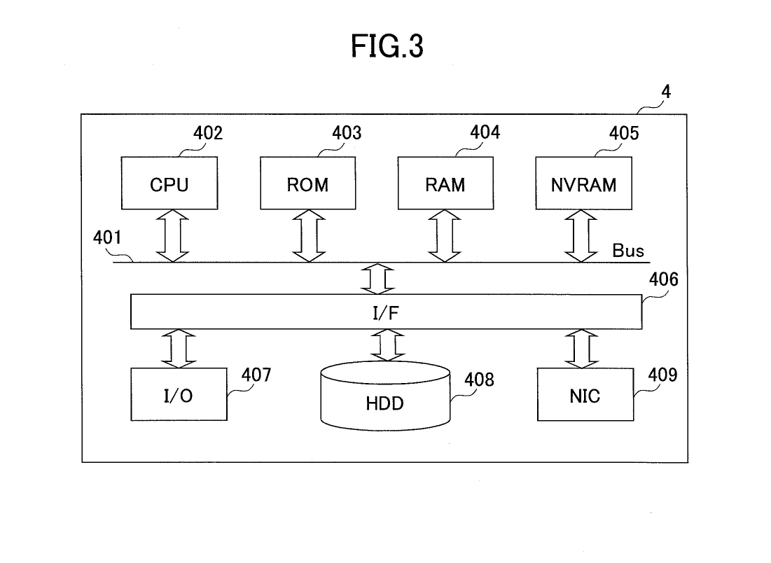

FIG. 3 is a block diagram illustrating an example of a hardware structure of the set sales processing system 4 of the embodiment.

The set sales processing system 4 includes a CPU (Central Processing Unit) 402, a ROM (Read Only Memory) 403, a RAM (Random Access Memory) 404, an NVRAM (Non-Volatile Random Access Memory) 405, and an I/F (Interface) 406 connected to a system bus 401, an I/O (Input/Output device) 407 for a keyboard, a mouse, a monitor, a CD/DVD (Compact Disk/Digital Versatile Disk) drive or the like, an HDD (Hard Disk Drive) 408 and an NIC (Network Interface Card) 409 connected to the I/F 406.

Note that the operator terminal device 1 may have the same hardware structure as that of the user terminal device 5 illustrated in FIG. 2, or may have the same hardware structure as that of the set sales processing system 4 illustrated in FIG. 3.

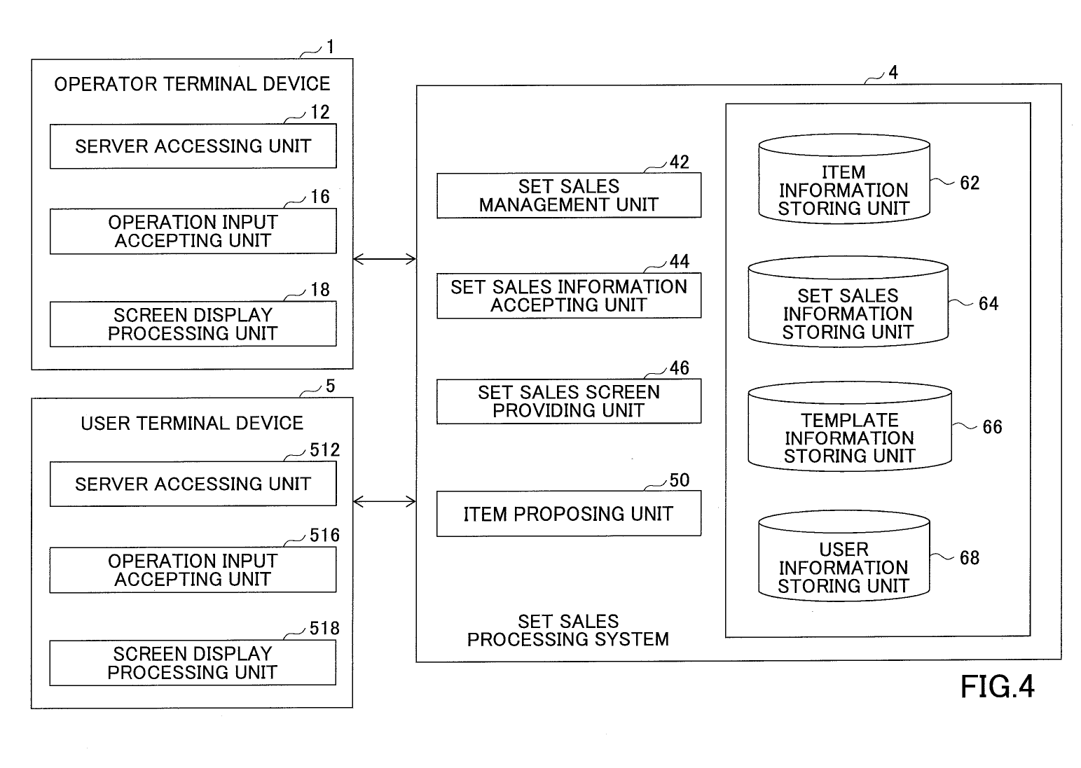

FIG. 4 is a block diagram illustrating a functional structure of the operator terminal device 1, the user terminal device 5, and the set sales processing system 4 of the embodiment.

The operator terminal device 1 includes a server accessing unit 12, an operation input accepting unit 16, and a screen display processing unit 18. The operation input accepting unit 16 accepts an operation input of an operator that operates the operator terminal device 1. The server accessing unit 12 sends a request to the set sales processing system 4 and receives a processed result or the like as a response from the set sales processing system 4 when it is necessary to access the set sales processing system 4 in a course of the processing. The screen display processing unit 18 displays screens.

The user terminal device 5 includes a server accessing unit 512, an operation input accepting unit 516, and a screen display processing unit 518. The server accessing unit 512, the operation input accepting unit 516, and the screen display processing unit 518 of the user terminal device 5 perform the same processes as the server accessing unit 12, the operation input accepting unit 16, and the screen display processing unit 18 of the operator terminal device 1, respectively.

The set sales processing system 4 includes a set sales management unit 42, a set sales information accepting unit 44, a set sales screen providing unit 46, an item proposing unit 50, an item information storing unit 62, a set sales information storing unit 64, a template information storing unit 66, and user information storing unit 68.

The set sales management unit 42 controls the entirety of the set sales processing system 4.

The item information storing unit 62 stores identification information (item ID) and an item image in association with each other, for a plurality of types of items.

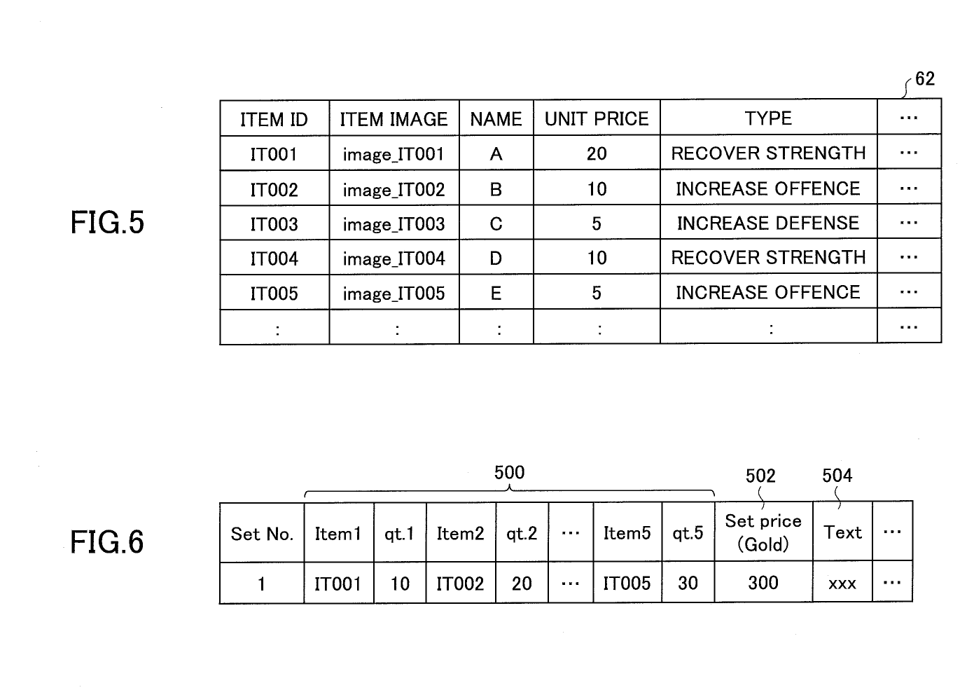

FIG. 5 illustrates an example of the internal structure of the item information storing unit 62 of the embodiment. The item information storing unit 62 includes items (fields) such as “item ID”, “item image”, “name”, “unit price”, and “type”.

The “item ID” is identification information of an item. The “item image” is an image such as a thumbnail image of the item. The “name” is information of a display name of the item. The “unit price” is information indicating the unit price of the item.

The “type” is information indicating the type of the item. For example, an item may be a game medium used in a game. In this case, the type may be changed according to the scene in which the game medium is used. In this example, “recover strength”, “increase offence”, and “increase defense” are stored as types.

Referring back to FIG. 4, the set sales information accepting unit 44 receives, from the operator via the operator terminal device 1, input of set sales information including a combination of the item IDs of a plurality of types of items sold as a set and the number of items included in the set, and the price of the set. When the operator gives an input start instruction of set sales information to the set sales processing system 4 via the operator terminal device 1, the set sales information accepting unit 44 displays, on the operator terminal device 1, an input screen for inputting necessary information. In this example, it is also possible to set an upper limit of the number of types of items included in a single set.

FIG. 6 illustrates an example of an input screen of set sales information of the embodiment.

The input screen of set sales information includes a combination field 500 of combinations of input fields of item IDs of a plurality of types of items (Item1 through Item5) and number input fields (qt.1 through qt.5), a set price field (Set price) 502, and a text input field (Text) 504. In the text input field 504, information relevant to the set (text information) is input. Furthermore, although not shown, the input screen of set sales information may also include an input field for inputting the sales period of the set. In the example of FIG. 6, five types of items may be included in a set.

Referring back to FIG. 4, the set sales information accepting unit 44 stores the received set sales information in the set sales information storing unit 64. The set sales information storing unit 64 may store a plurality of set sales information items received by the set sales information accepting unit 44.

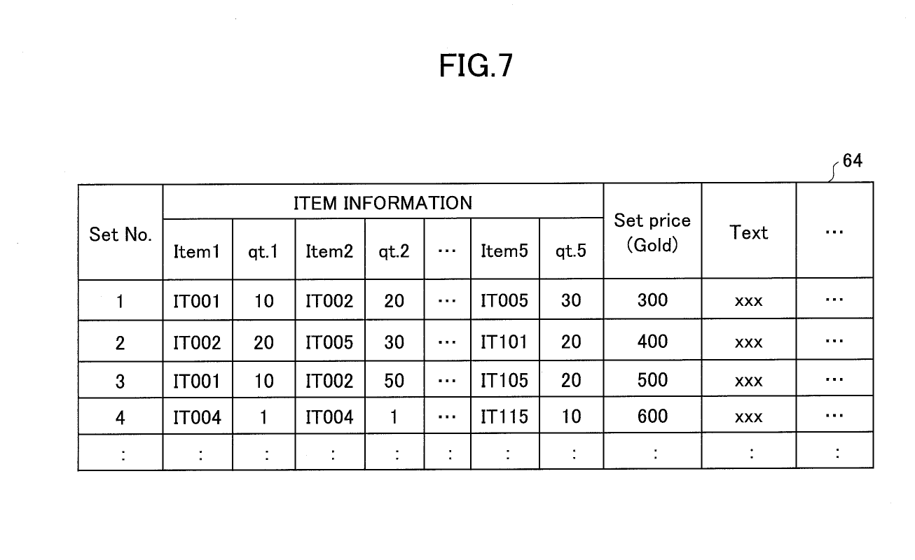

FIG. 7 illustrates an example of the internal structure of the set sales information storing unit 64 of the embodiment.

The set sales information storing unit 64 includes items (fields) such as “set number” (Set No.), “item information”, “set price” (Set price), and “text” (Text). The “set number” is information specifying (identifying) each set sales information item. The “item information” corresponds to the combination field 500 that is a combination of the item ID input field and the number input field in the input screen of set sales information described with reference to FIG. 6. The “set price” and “text” also correspond to the set price field 502 and the text input field 504 of FIG. 6, respectively.

Referring back to FIG. 4, the template information storing unit 66 stores template information for providing a template screen including combinations of a plurality of item image display areas and number display areas, and a price display area.

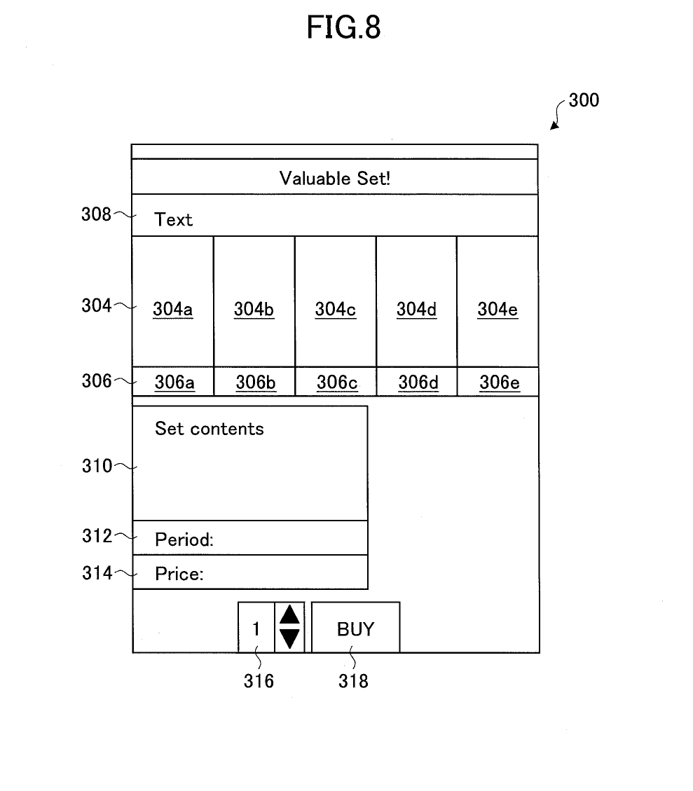

FIG. 8 illustrates an example of a template screen 300 based on template information stored in the template information storing unit 66.

The template screen 300 includes a plurality of item image display areas 304 (the item image display areas are distinguished by being denoted as 304a through 304e), a plurality of number display areas 306 (the number display areas are distinguished by being denoted as 306a through 306e), a text display field 308, a set content display field 310, a sales period display field 312, a price display field 314, a set number display field 316, and a purchase button 318.

In the template screen 300, combinations of the item image display areas 304a through 304e and the number display areas 306a through 306e are provided as pairs, and the plurality of item image display areas 304a through 304e are arranged adjacent to each other. Note that the template information storing unit 66 does not store such a template screen 300 as an image; the template information storing unit 66 stores the data in a format that can provide the template screen 300, as template information.

Referring back to FIG. 4, the set sales screen providing unit 46 acquires, from the item information storing unit 62, a plurality of item images respectively corresponding to the item IDs of a plurality of types of items included in the set sales information, based on the set sales information stored in the set sales information storing unit 64. Next, the set sales screen providing unit 46 generates a set sales screen including a set image, in which the item images, the number, and a price are incorporated in the template screen.

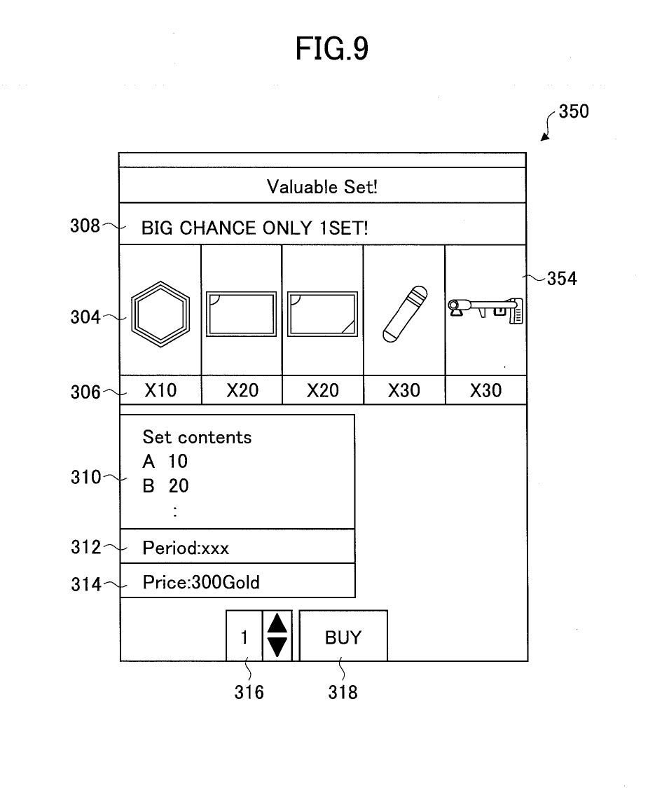

FIG. 9 illustrates an example of a set sales screen 350 generated by the set sales screen providing unit 46.

The set sales screen 350 includes a plurality of item image display areas 304, a plurality of number display areas 306, a text display field 308, a set content display field 310, a sales period display field 312, a price display field 314, a set number display field 316, and a purchase button 318, corresponding to the template screen 300 illustrated in FIG. 8.

In the set sales screen 350, in the plurality of item image display areas 304 and the plurality of number display areas 306, item images 354 and numbers of items corresponding to the item IDs specified in the set sales information are displayed, respectively. In this example, the set sales screen 350 may display the item images, in the order that the data has been input to the combination field 500 including combinations of the item ID input fields and the number input fields described with reference to FIG. 6.

In the text display field 308, text information is displayed, which is input to the text input field 504 described with reference to FIG. 6. In the set content display field 310, text information is displayed, which indicates the names of the items and numbers, corresponding to the item images displayed in the plurality of item image display areas 304 and the plurality of number display areas 306. When there is an input field included for inputting the sales period of the set in the input screen described with reference to FIG. 6, and a sales period is input, the sales period is displayed in the sales period display field 312. In the price display field 314, the price of the set input to the set price field 502 described with referent to FIG. 6, is displayed.

In the set number display field 316, the number of sets to be purchased is displayed. The user who is the purchaser can change the number of sets. In the set sales screen 350, for example, when the user changes the number of sets from “1” to “2”, the price in the price display field 314 may be changed, or another field for displaying the total amount may be provided. Furthermore, in the set sales information, a message indicating to apply a discount may be set when a plurality of sets are purchased at once. In this case, a price to which the discount has been applied may be displayed in the set sales screen 350.

Referring back to FIG. 4, the set sales screen providing unit 46 can adjust the resolution of each item image included in the set image, according to the number of the plurality of types of items included in the set sales information. In one example, when there are greater than or equal to three types of items included in the input set sales information, the resolution of the item image is set to 45×45 pixels, and when there are less than or equal to two types of items included in the input set sales information, the resolution of the item image is set to 64×64 pixels.

Furthermore, the template information storing unit 66 may store a plurality of types of template information for providing a plurality of types of template screens having different numbers of item image display areas 304. The set sales screen providing unit 46 may select template information for providing a template screen including a corresponding number of item image display areas 304, according to the number of types of items included in the set sales information.

Referring back to FIG. 4, the user information storing unit 68 stores various types of user information of the user who is the purchaser. In the embodiment, the user information storing unit 68 stores history information relevant to the usage of the item by the user, in association with the user. The history information may include, for example, activity history information indicating the usage of the item by the user, acquisition history information of acquiring the item by the user, and purchase history information of purchasing the item by the user. Furthermore, for example, when the item included in the set is a game medium used in a game, the history information may be the game play history information of the user.

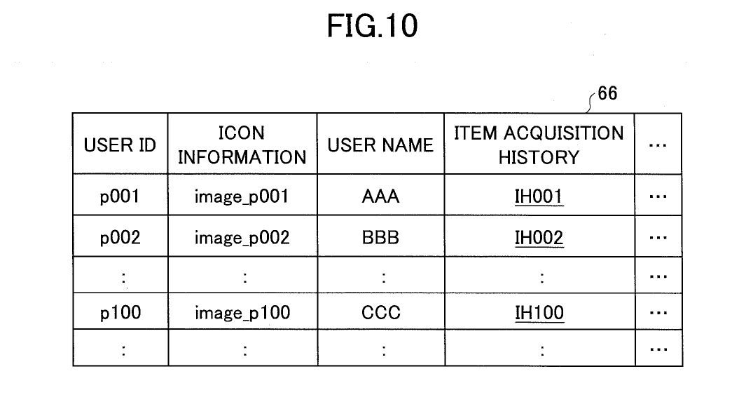

FIG. 10 illustrates an example of the internal structure of the user information storing unit 68 of the embodiment.

The user information storing unit 68 includes items (fields) such as “user ID”, “icon information”, “user name”, and “item acquisition history”.

The “user ID” is information for specifying (identifying) the user. The “icon information” is information for specifying the display icon of the user. The “user name” is information of the display name of the user. The “item acquisition history” is the acquisition history information of the item by the user. The acquisition history information of the item may be a list in which the status of acquiring the item by the user is associated with the information of the item.

Referring back to FIG. 4, in the embodiment, the user may perform a process to exclude all of or some of one of the types of items in the actual set, among the plurality of types of items included in the set. The item proposing unit 50 may receive such a process from the user, and propose to the user the candidate items to be included in the set instead of all of or some the items that have been processed to be excluded from the set. In this case, the item proposing unit 50 may refer to the user information storing unit 68, and propose, as candidate items to the user, the same types of items as those having a high usage frequency, based on the history information relevant to the usage of the item by the user.

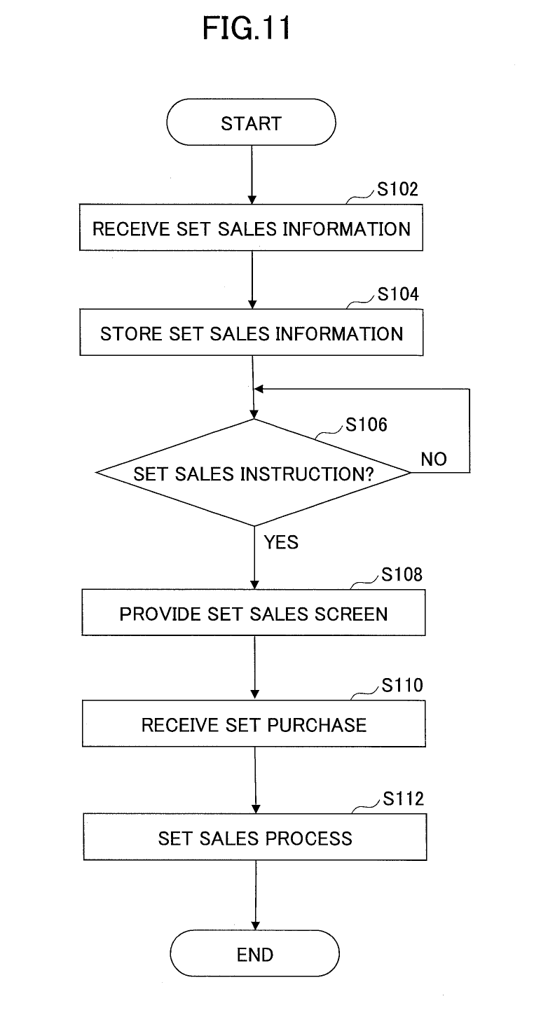

FIG. 11 is a flowchart of an example of processing procedures of the set sales processing system 4 of the embodiment.

First, the set sales information accepting unit 44 receives input of set sales information form the operator via the operator terminal device 1 (step S102). The set sales information accepting unit 44 stores the received set sales information (step S104).

When there is a set sales instruction specifying one of the set sales information items stored in the set sales information accepting unit 44 (YES in step S106), the set sales screen providing unit 46 generates a set sales screen and provides the set sales screen to the user terminal device 5 (step S108). Specifically, the set sales screen providing unit 46 acquires, from the item information storing unit 62, a plurality of item images corresponding to the item IDs of the plurality of types of items included in the set sales information based on the specified set sales information. Next, the set sales screen providing unit 46 generates a set sales generates a set sales screen including a set image formed by incorporating the item images and numbers, and the price in the template image, and provides the set sales screen to the user terminal device 5.

When the user performs a set purchase process via the user terminal device 5, the set sales management unit 42 receives the set purchase instruction (step S110), and performs the set sales process (step S112). Note that when the user accesses the set sales processing system 4 from the user terminal device 5, the user is identified by a user ID and a password. Furthermore, as described below in specific examples, when the item included in the set is changed according to a selection by the user, the set sales management unit 42 performs a set sales process corresponding to the changed contents.

Next, a description is given of specific examples of the set sales processing system 4.

### Specific Example 1

For example, in step S106 illustrated in FIG. 11, the set sales information may be specified by the following procedures.

In one example, the user (purchaser) of the user terminal device 5 may input a desired price of the set. When the input of a desired price is received from the purchaser, the set sales screen providing unit 46 refers to the set sales information storing unit 64, and extracts set sales information in which the price of the set included in the set sales information matches the desired price of the purchaser. Next, the set sales screen providing unit 46 generates a set sales screen based on the extracted set sales information.

At this time, when there are a plurality of set sales information items in which the price of the set matches the desired price of the purchaser, the set sales screen providing unit 46 generates a set sales screen based on the respective set sales information items and provide the set sales information items as a list to the user terminal device 5.

### Specific Example 2

Furthermore, the set sales information includes combinations of identification information of a plurality of types of items that are more than the predetermined number of items that are actually included in the set, and the number of items to be included in the set. The user of the user terminal device 5 may select a predetermined number of combinations from among the above combinations. In this example, the set sales information accepting unit 44 also receives, form the operator via the operator terminal device 1, a specification of the number of types (predetermined number) of items to be actually included in the set.

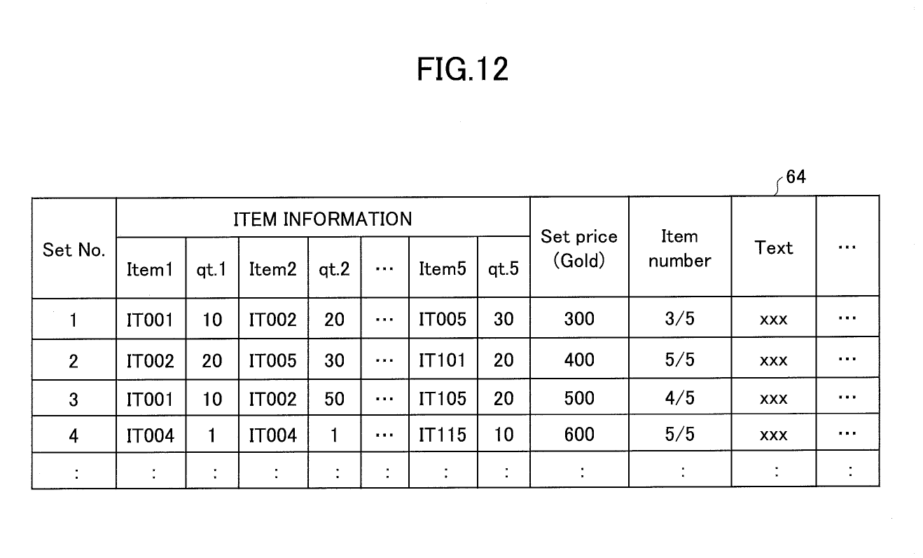

FIG. 12 illustrates an example of the internal structure of the set sales information storing unit 64 of the embodiment.

In this example, the set sales information storing unit 64 includes an item of “item number”, in addition to the structure illustrated in FIG. 7. The “item number” is information indicating the number of types (predetermined number) of items to be actually included in the set. In this example, the “item number” of the set sales information having the set number (set no.) 1 is “3/5”. This means to select three types of items from among the five types of items included in the set sales information.

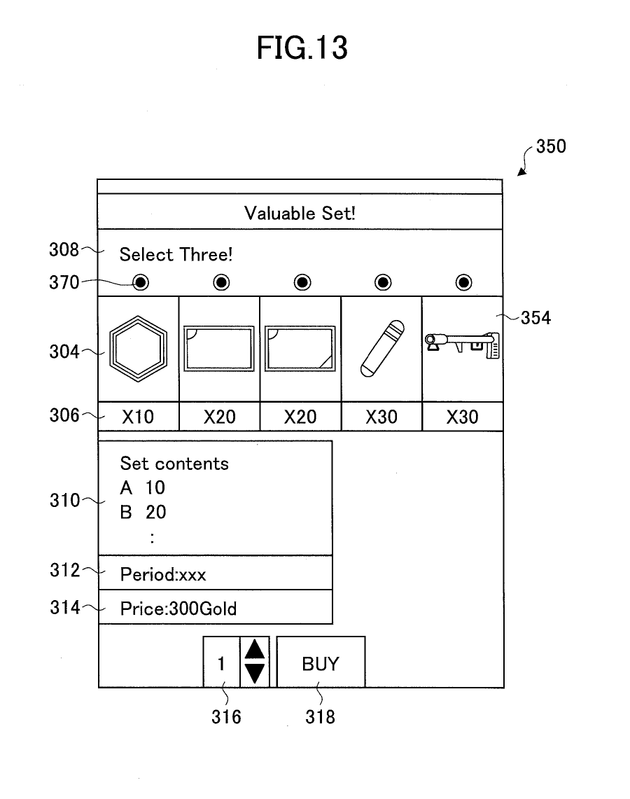

FIG. 13 illustrates the set sales screen 350 of the embodiment.

The set sales screen providing unit 46 displays selection buttons 370 in the set sales screen 350 in association with a plurality of item images 354. The selection buttons 370 are for selecting an item to be actually included in the set from among the plurality of item images 354 included in the set sales screen 350. The set sales screen providing unit 46 receives, from the purchaser, the selection by the selection button 370 corresponding to the number of types of items received by the set sales information accepting unit 44. As described above, when the “item number” of the set sales information is “3/5”, the user can select three selection buttons 370 from among five selection buttons 370. In this case, a message is displayed in the text display field 308, indicating that three selection buttons can be selected. Note that the selection buttons 370 may be radio buttons as illustrated in FIG. 13, or may be check buttons. Note that in this case, the prices of the combinations of item×number are set so as to be substantially equal.

### Specific Example 3

Furthermore, as described above, in the embodiment, the user can perform a process of excluding, from the actual set, some of the items among the plurality of types of items included in the set. That is to say, the set sales processing system 4 provides, by the set sales screen providing unit 46, a set sales screen including item images of a plurality of types of items to the user; however, among the plurality of types of items, the user may select unnecessary items and exclude the selected items from the set.

The item proposing unit 50 receives from the user, a process of excluding, from the actual set, some of the items among the plurality of types of items corresponding to the plurality of item images included in the set image. In this case, for example, the selection buttons similar to those illustrated in FIG. 13 are displayed in the set sales screen, and the user can select the items to be excluded from the actual set. Furthermore, the item proposing unit 50 proposes, to the user, candidate items to be included in the set instead of the items that have been selected to be excluded from the set. The item proposing unit 50 can propose, to the user, the candidate items in consideration of the user's preferences.

For example, the item proposing unit 50 may refer to the user information storing unit 68, and propose to the user as a candidate item, the same type of item as an item having a high usage frequency, based on the history information relevant to the usage of the item by the user.

For example, as described with reference to FIG. 5, it is assumed that the item included in a set is a game medium of an item used in a game, and that the history information stored in the user information storing unit 68 is the game play history information of the user. In this example, when an item type “recover strength” is frequently purchased and used according to the game play history information of the user, the item proposing unit 50 can propose the item type “recover strength” as the candidate item to the user.

Note that the set sales information stored in the set sales information storing unit 64 may include a plurality of combinations of item to be candidate item×number. In this case, the prices of the respective combinations of item×number may be set to be substantially equal, and the plurality of combinations of item to be candidate item×number may also be set to have substantially equal to the price of the respective combinations of item×number.

Furthermore, a plurality of combinations of item to be candidate item×number may be set for each of the combinations of item×number included in the set. Furthermore, the prices of the respective combinations of item×number may be set to be different from each other. In this case, the combination of item to be candidate item×number may be set to have a substantially equal price to that of the combination of item to be excluded×number.

Furthermore, in another example, the item proposing unit 50 may propose to the user as a candidate item, the same type of item as an item other than an item that has been subjected to the process of being excluded from the actual set, from among the plurality of types of items corresponding to the plurality of item images included in the set image.

Furthermore, the set sales screen providing unit 46 may generate a set sales screen such that the number of at least some of the items can be changed by the user. That is to say, the set sales screen providing unit 46 may provide the set sales screen 350 such that the user can arbitrarily change the number displayed in the number display area 306 of the set sales screen 350 illustrated in FIG. 9. In this case, instead of excluding all of the number of items of a certain item type from a set, it is possible to exclude some of the items of the certain item type, i.e., the number may be reduced. In this case also, the item proposing unit 50 may propose another item having the same price, as the candidate item to the user, based on the reduced number of items. Note that the item that may be excluded from a set or that may be reduced in quantity may be specified in the set sales information.

### Specific Example 4

Furthermore, the set sales screen providing unit 46 may generate a set sales screen such that the user can change the number of at least one of the items. Also, when the number of one of the items is reduced among the plurality of types of items included in a set, the set sales screen providing unit 46 may receive an increase in the number of another item. In this case, the set sales screen providing unit 46 receives, from the user, an increase in the number of another item of the same price, based on the reduced number of items. Note that in the set sales information, the item whose number can be reduced may be specified.

In the embodiment, by the above structure, a technique is provided, which is capable of simplifying the process when selling a plurality of items as a set, and enhancing flexibility.

Note that the respective components in the operator terminal device 1, the user terminal device 5, and the set sales processing system 4 illustrated in FIG. 4 do not indicate hardware units, but the components indicate blocks of functional units. The components in the operator terminal device 1, the user terminal device 5, and the set sales processing system 4 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications. Further, functions performed by the set sales processing system 4 may be unnecessarily actualized in a single apparatus and may be distributed in a plurality of apparatuses.

Although a preferred embodiment has been specifically illustrated and described, it is to be understood that minor modifications may be made therein without departing from the spirit and scope of the invention as defined by the claims.

In the set sales screen 350, among the plurality of types of items, with regard to an item to which the attention of the user is to be particularly attracted, the background of the item image may be different from those of item images of other items. In this case, in the input screen of the set sales information illustrated in FIG. 6, an input field may be provided for specifying the item to have a different background and specifying information indicating the background.

Furthermore, the above embodiment describes an example where the item is a game medium used in a game; however, the item may be a merchandise item or a service that is sold in regular online shopping.

Furthermore, as described above, when the item included in a set is a game medium used in a game, the set sales processing system 4 may be included in a game management server for managing the game. In this case, the method of executing the game may be a “browser type” or an “application type”. The browser type is for performing a process of managing screen transition information (View information) describing a series of display control contents of the screen in accordance with the progress of the game on the game management server side, sending a HTML data document and data such as images associated with the HTML data document to the user terminal device 5 according to a data acquisition request made by an input operation from the user terminal device 5, and displaying the data with a web browser in the user terminal device 5. Meanwhile, the application type is for performing a process of downloading game application software (application program) to the user terminal device 5 from a set game management server in advance, executing the game application software in the user terminal device 5, and generating and displaying screen information based on screen transition information included in the game application software stored in the user terminal device 5 according to the download, and data acquired form the server when an input operation is made.

What is claimed is:

1. A set sales processing system comprising:
a set sales information accepting unit that receives input of set sales information including combinations of identification information respectively corresponding to a plurality of types of items to be sold in a set, numbers of the respective items to be included in the set, and a price of the set;
a set sales screen providing unit that
acquires, from an item information storing unit, a plurality of item images respectively corresponding to the identification information of the plurality of types of items included in the set sales information, wherein the item information storing unit stores, for each of the plurality of types of items, identification information and one of the plurality of item images in association with each other, based on the set sales information, and
generates a set sales screen including a set image in which the plurality of item images, the numbers, and the price are incorporated in a template screen, the template screen including a plurality of combinations of item image display areas and number display areas, and a price display area; and
an item proposing unit that
receives, from a purchaser, a process to exclude, from an actual one of the set, all of or some of a type of item among the plurality of types of items corresponding to the plurality of item images included in the set image, and
proposes, to the purchaser based on history information relevant to usage of items by the purchaser, an item that is a same type as an item that is highly frequently used by the purchaser, as a candidate item to be included in the set instead of all of or some of the type of item that has been processed to be excluded from the set.

2. The set sales processing system according to claim 1, wherein
in the template screen, the item image display area and the number display area in each of the plurality of combinations are provided in pairs, and the item image display areas are arranged adjacent to each other.

3. The set sales processing system according to claim 1, wherein
the set sales screen providing unit adjusts a resolution of each of the plurality of item images to be included in the set image, according to a number of the plurality of types of items included in the set sales information.

4. The set sales processing system according to claim 1, wherein
the items are game media used in a game, and
the history information is game play history information of a user.

5. The set sales processing system according to claim 1, further comprising:
a set sales information storing unit that stores a plurality of the set sales information received by the set sales information accepting unit, wherein
the set sales screen providing unit receives an input of a desired price from the purchaser, and generates the set sales screen based on one of the plurality of the set sales information including a price of the set that matches the desired price of the purchaser.

6. A non-transitory computer-readable recording medium storing a program for a set sales processing system, wherein the program causes a computer to execute a process, the process comprising:
receiving input of set sales information including combinations of identification information respectively corresponding to a plurality of types of items to be sold in a set, numbers of the respective items to be included in the set, and a price of the set;
acquiring, from an item information storing unit, a plurality of item images respectively corresponding to the identification information of the plurality of types of items included in the set sales information, wherein the item information storing unit stores, for each of the plurality of types of items, identification information and one of the plurality of item images in association with each other, based on the set sales information;
generating a set sales screen including a set image in which the plurality of item images, the numbers, and the price are incorporated in a template screen, the template screen including a plurality of combinations of item image display areas and number display areas, and a price display area;
receiving, from a purchaser, a process to exclude, from an actual one of the set, all of or some of a type of item among the plurality of types of items corresponding to the plurality of item images included in the set image; and
proposing, to the purchaser based on history information relevant to usage of items by the purchaser, an item that is a same type as an item that is highly frequently used by the purchaser, as a candidate item to be included in the set instead of all of or some of the type of item that has been processed to be excluded from the set.

7. The non-transitory computer-readable recording medium according to claim 6, wherein
the items are game media used in a game, and
the history information is game play history information of a user.
